(19) United States
(12) Patent Application Publication
(10) Pub. No.: US 2002/0126442 A1
(43) Pub. Date: Sep. 12, 2002

(54) Piggyback monitor

(75) Inventors: Chul-Ho Lim, Seoul (KR); Soo-Yen Lim, Seoul (KR)

Correspondence Address: Richard S. Milner, Cooper & Dunham LLP, 1185 Avenue of the Americas, New York, NY, 10036, US

(73) Assignee: ED-Tech Co., Ltd., Seoul (KR)

(21) Appl. No.: 10/093,763

(22) Filed: Mar. 8, 2002

(30) Foreign Application Priority Data
Mar. 12, 2001 (KR) 2001-12608

(51) Int. Cl. G06F 1/16; G02F 1/1333

(52) U.S. Cl. 361/681; 349/58

(57) ABSTRACT

Disclosed is a piggyback monitor, to which various systems according to necessity can be mounted, so that the monitor with the systems can be conveniently used even in a narrow space. The piggyback monitor has connectors provided at a back of a monitor, to be connected with systems; links provided at a side and the back of the monitor, to fix a plurality of systems; and a stand for supporting and controlling the monitor and the systems. By the piggyback monitor, a plurality of systems can be assembled and connected with each other to be used as a single system, so that their entire volume and weight are decreased. Consequently, the assembled systems can be easily moved and installed in any space. Moreover, the systems can be connected with each other only through connectors without a cable, so that noise due to the cable and a problem of a complicated layout of the cable can be eliminated.

### BACKGROUND OF THE INVENTION

1. Field of the Invention

The present invention relates to a digital flat panel monitor, and more particularly to a piggyback monitor, to which various systems according to necessity can be mounted, so that the monitor with the systems can be conveniently used even in a narrow space.

2. Description of the Related Art

FIG. 1 is a perspective view of a conventional cathode ray tube (CRT) monitor, which will be described hereinafter.

The CRT monitor 100 includes a CRT 10, a monitor body 12 provided at the back of the CRT 10, and a stand 14 for supporting the monitor body 12 and the CRT 10.

The CRT monitor is of an analog type and has a shape, which is large and protrudes backward due to an electron gun for forming a screen.

Recently, the monitor shows a tendency to be thinner and to consume less electric power, according to an advent of a monitor utilizing a digital flat panel such as a thin film transistor-liquid crystal display (TFT-LCD).

Further, even in the case where the thin monitor as described above is used, the volume of a personal computer (PC) is still large. Moreover, for the digital TV (D-TV), only the screen is changed from analog to digital, and the system is not changed, so that there is a difficulty in interconnecting the systems including the D-TV, a digital versatile disc (DVD), a set-top box, etc.

As described above, in the prior art, even in the case where the monitor is thin, the systems such as the PC, the D-TV, the DVD, and the set-top box are large, and it is difficult and complicated to connect the systems with each other.

### SUMMARY OF THE INVENTION

Accordingly, the present invention has been made in an effort to solve the problems occurring in the related art, and it is an object of the present invention to provide a piggyback monitor, which enables a single digital screen system to be connected with multi-systems, so that the systems can be conveniently used according to necessity and the space for the systems can be utilized as efficiently as possible.

In accordance with one aspect, the present invention provides a piggyback monitor comprising: connectors provided at a back of a monitor, to be connected with systems; links provided at a side and the back of the monitor, to fix a plurality of systems; and a stand for supporting and controlling the monitor and the systems.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view of a conventional CRT monitor;

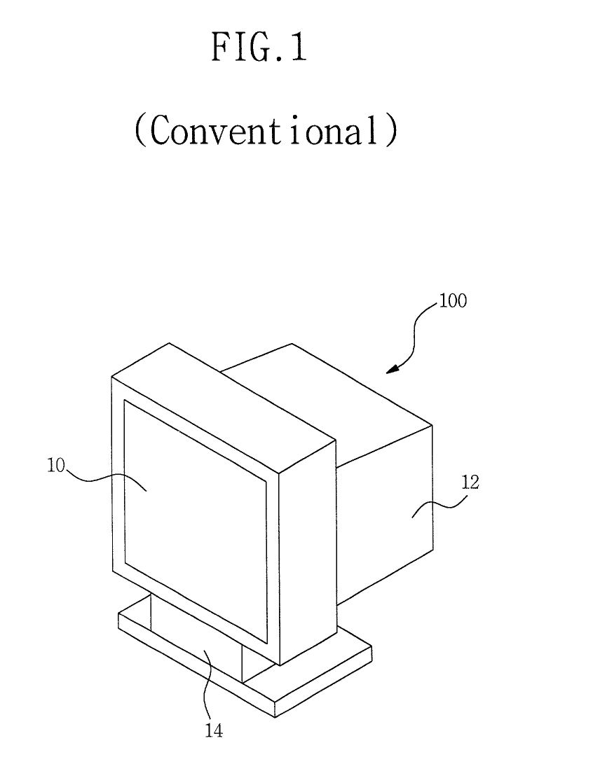

FIG. 2 is a perspective view of a TFT-LCD monitor employed in the present invention;

FIG. 3 is a rear view of the TFT-LCD monitor employed in the present invention;

FIG. 4 is a perspective view of a piggyback monitor according to the present invention;

FIG. 5 is a rear perspective view of the piggyback monitor according to the present invention; and

FIG. 6 is a rear view of the piggyback monitor according to the present invention.

### DETAILED DESCRIPTION OF PREFERRED EMBODIMENTS

The above and other objects, characteristics, and advantages of the present invention will be apparent from the following description along with the accompanying drawings.

The piggyback monitor of the present invention includes connectors 32, 34, and 36 provided at the back of the monitor 10, to be connected with systems 16, 18, 20, 22, and 24, links 30 provided at the side and the back of the monitor 10, to fix the systems 16, 18, 20, 22, and 24, and a stand 14 for supporting and controlling the monitor 10 and the systems 16, 18, 20, 22, and 24.

The links 30 are provided at the upper and the lower, and the left and the right edges of the back and the side of the monitor 10.

As the systems 16, 18, 20, 22, and 24, a PC 16, a DVD 18, a D-TV 20, a set-top box 22, and a mobile phone may be employed.

The systems 16, 18, 20, 22, and 24 can be assembled with and detached from the monitor 10.

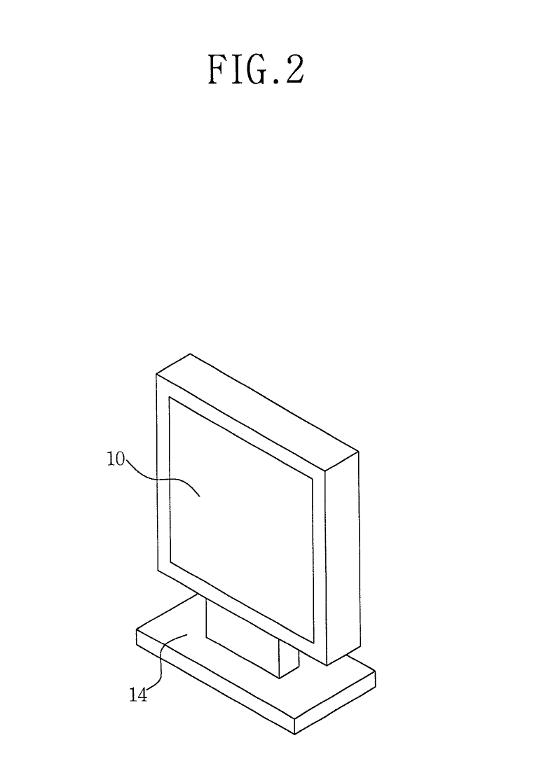

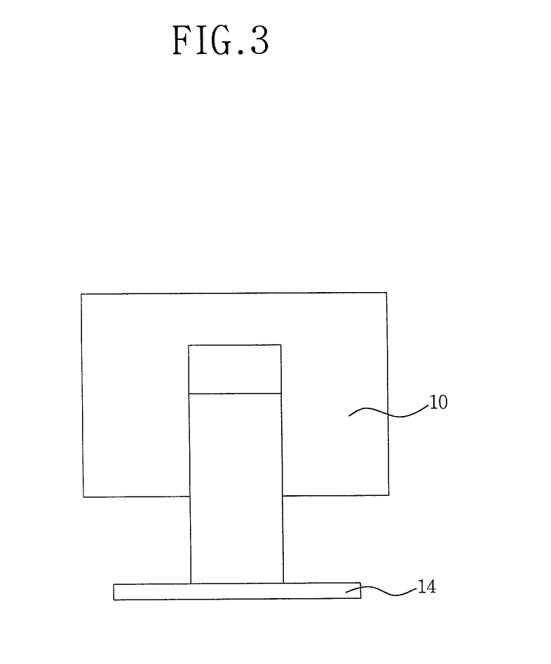

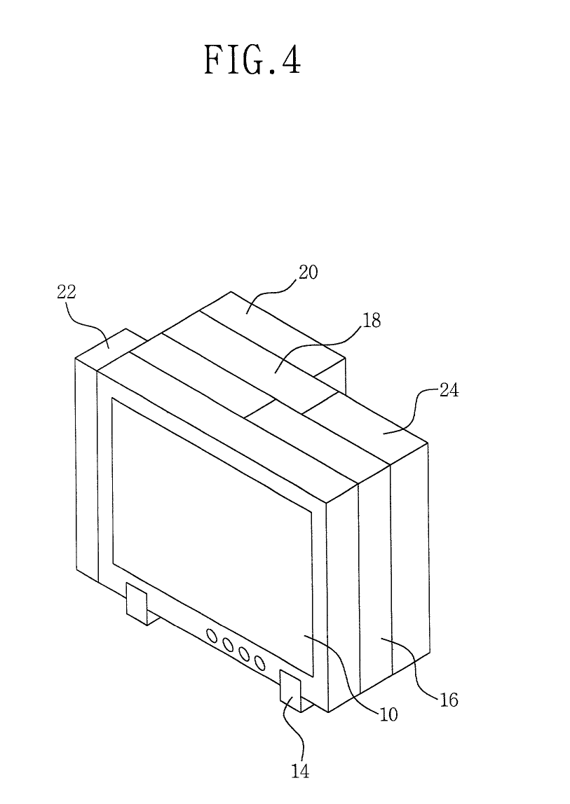

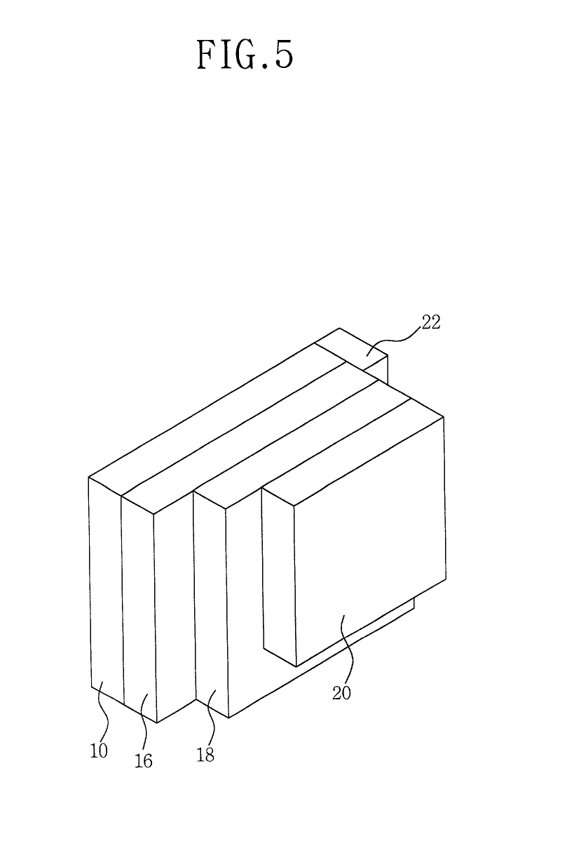

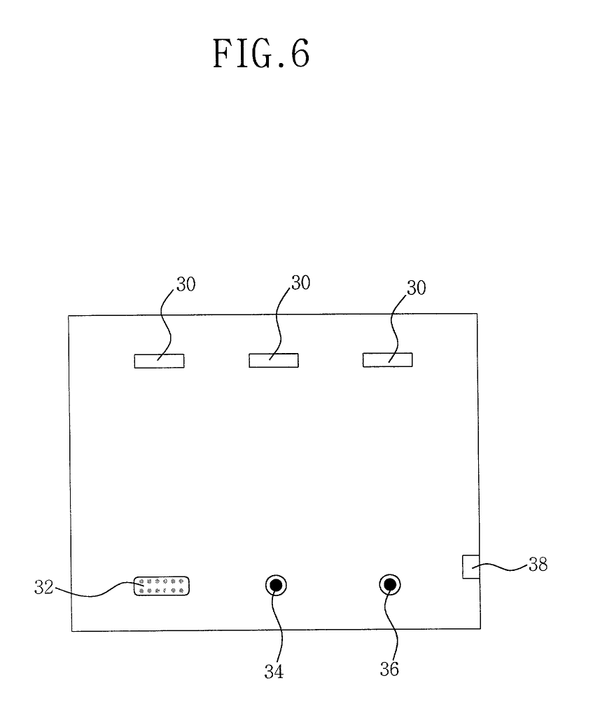

FIG. 2 is a perspective view of a TFT-LCD monitor employed in the present invention, FIG. 3 is a rear view of the TFT-LCD monitor employed in the present invention, FIG. 4 is a perspective view of a piggyback monitor according to the present invention, FIG. 5 is a rear perspective view of the piggyback monitor according to the present invention, and FIG. 6 is a rear view of the piggyback monitor according to the present invention. The following description will be given with reference to these drawings.

The piggyback monitor of the present invention is an image digital flat panel system or an image monitor system such as the flat panel TFT-LCD and the PDP, which may be used together with various systems according to the necessity or the purpose of use.

In other words, according to the purpose of use, various systems such as a set-top box, a PC, a D-TV, a DVD, a mobile phone and the like can be assembled at the side and the back of the image monitor system, which is flat and manufactured as a monitor or a video system.

As an embodiment of the present invention, FIGS. 2 and 3 show a TFT-LCD monitor employing a digital flat panel, which is light and thin, consumes reduced electric power, and has no radiation of X ray and no phenomenon of shaking.

The stand 14 is provided at the back of the monitor 10, to distribute the weight of the monitor 10 and adjust a standing angle of the monitor 10.

As shown in FIGS. 4 and 5, various systems such as the PC, the DVD, and the set-top box may be assembled with the flat panel display monitor. Further, the assembled monitor can be simply installed to a desk, a table, a wall, etc., so that the monitor with the systems takes relatively small space, thereby increasing the space availability.

That is, a PC connection terminal 32 and a PC fixing terminal or link 30 are formed at the back of the monitor 10, to assemble the PC with the monitor. Further, the DVD 18, the D-TV 20, the set-top box 22, and the mobile phone 24 are assembled with the back of the monitor 10, and then the monitor 10 with the systems is fixed to a desk or a wall.

Meanwhile, the links 30 are formed at the upper and the lower, and the left and the right edges of the side and back of the monitor 10, so that the systems 16, 18, 20, 22, and 24 can be assembled with and detached from the monitor 10 by means of the links 30.

More detailed description will be given hereinafter.

The monitor 10 employing a flat display panel is used in a state that the systems 16, 18, 20, 22, and 24 are assembled with the monitor 10.

That is, the flat panel display monitor 10 is used together with the systems 16, 18, 20, 22, and 24, and the systems 16, 18, 20, 22, and 24 are assembled with or detached from the monitor 10 according to the purpose of use.

The connections between the monitor 10 and the systems 16, 18, 20, 22, and 24 may have a shape of a turtle's neck or a shape of a spring. Otherwise, by means of cables, those thin systems may be installed in a narrow space or the monitor may be hung on a wall.

Further, the monitor 10 and the systems 16, 18, 20, 22, and 24 are supported by the stand 14.

As shown in FIGS. 4 to 6, necessary systems such as the PC, the DVD, and the D-TV are connected through normal connectors provided at the back of the flat panel monitor to the monitor, and then they are installed to a desk or a wall.

In this case, the monitor 10 and the PC 16 are operated when the monitor 10 and the PC 16 are connected with each other, while the DVD system 18 is operated when the monitor 10 and the DVD system are connected with each other.

The D-TV system is operated when the monitor 10 and the D-TV 20 are connected with each other, while a cable TV system is operated when the monitor 10 and the set-top box 22 are connected with each other.

When the monitor 10 and the mobile phone 24 are connected with each other, a mobile phone system of a large-screen-dynamic image is operated.

Therefore, in the present invention, a digital flat panel monitor system having multimedia function can be installed in a narrow space, and the digital flat panel monitor system for processing data signals and video signals can be operated normally even when the system is connected with other systems. Further, the present invention enables the monitor system to be connected with a plurality of other systems.

According to the present invention as described above, a plurality of systems can be assembled and connected with each other to be used as a single system, so that their entire volume and weight are decreased. Consequently, the assembled systems can be easily moved and installed in any space. Moreover, since the systems can be connected with each other only through connectors without a cable, noise due to the cable and a problem of a complicated layout of the cable can be eliminated.

In addition, the present invention arranges a system industrial field, in which the flat panel image system can be utilized as well as possible.

While there have been illustrated and described what are considered to be preferred specific embodiments of the present invention, it will be understood by those skilled in the art that the present invention is not limited to the specific embodiments thereof, and various changes and modifications and equivalents may be substituted for elements thereof without departing from the true scope of the present invention.

What is claimed is:

1. A piggyback monitor comprising:
connectors provided at a back of a monitor, to be connected with systems;
links provided at a side and the back of the monitor, to fix a plurality of systems; and
a stand for supporting and controlling the monitor and the systems.

2. The piggyback monitor as claimed in claim 1, wherein the links are provided at upper, lower, left and right edges of the back and the side of the monitor 10.

3. The piggyback monitor as claimed in claim 1, wherein the systems comprise a personal computer, a digital versatile disc system, a digital television, a set-top box, and a mobile phone.

4. The piggyback monitor as claimed in claim 1 or 3, wherein the systems can be assembled with and detached from the monitor.
